(19) United States
(12) Patent Application Publication
(10) Pub. No.: US 2001/0021950 A1
(43) Pub. Date: Sep. 13, 2001

(54) METHOD AND APPARATUS FOR CONTROLLING ACCESS TO A COMPUTER NETWORK USING TANGIBLE MEDIA

(76) Inventors: MICHAEL HAWLEY, CAMBRIDGE, MA (US); HENRY HOLTZMAN, BOSTON, MA (US); ANDREW LIPPMAN, SALEM, MA (US); MANISH TUTEJA, FOSTER CITY, CA (US)

Correspondence Address: TESTA, HURWITZ & THIBEAULT, LLP, HIGH STREET TOWER, 125 HIGH STREET, BOSTON, MA, 02110, US

(21) Appl. No.: 09/113,206

(22) Filed: Jul. 10, 1998

(51) Int. Cl. G06F 15/173

(52) U.S. Cl. 709/225

(57) ABSTRACT

Interaction with a computer network is facilitated or restricted based on a tangible token, such as a small card or disk, a small everyday article, a toy, or a product container. The token comprises a machine-readable indication, or “tag,” that identifies the token and which may be wirelessly read by a tag reader. The tag reader communicates the identifier to a computer connected to the network as a node. The computer, in response, determines and implements a network-access criterion based on the token. Generally, the computer maintains a database relating token identifiers to associated network-access criteria, and consults the database when presented with an identifier. The access criterion specifies information governing interaction between the computer and the network, and can serve to initiate connections or restrict them.

### FIELD OF THE INVENTION

The present invention relates to computer networks, and in particular to the establishment and governing of connections between networked computers.

### BACKGROUND OF THE INVENTION

A computer network is a geographically distributed collection of interconnected subnetworks for transporting data between stations, such as computers. A local area network (LAN) is an example of such a subnetwork consisting of a transmission medium, such as coaxial cable or twisted pair, that facilitates relatively short-distance communication among interconnected computer stations. The stations typically communicate by exchanging discrete packets or frames of data according to predefined protocols. In this context, a protocol denotes a set of rules defining how the stations interact with each other.

Such interaction is simple within a LAN, since these are typically “multicast” networks: when a source station transmits a frame over the LAN, it reaches all stations on that LAN. If the intended recipient of the frame is connected to another LAN, the frame is passed over a routing device to that other LAN. Collectively, these hardware and software components comprise a communications network and their interconnections are defined by an underlying architecture.

The Internet is a worldwide “network of networks” that links millions of computers through tens of thousands of separate (but intercommunicating) networks. Via the Internet, users can access tremendous amounts of stored information and establish communication linkages to other Internet-based computers. Much of the Internet is based on the “client-server” model of information exchange. This computer architecture, developed specifically to accommodate the distributed computing environment that characterizes the Internet and its component networks, contemplates a server (sometimes called the host)—typically a powerful computer or cluster of computers that behaves as a single computer—which services the requests of a large number of smaller computers, or clients, which connect to it. The clients may be simple personal computers and usually communicate with a single server at any one time (although they can communicate with one another via the server or can use a server to reach other servers). A server is typically a large mainframe or minicomputer cluster capable of simultaneous data exchange with multiple clients.

In order to ensure proper routing of messages between the server and the intended client, the messages are first broken up into data packets, each of which receives a destination address according to a protocol, and which are reassembled upon receipt by the target computer. A commonly accepted set of protocols for this purpose are the Internet Protocol, or IP, which dictates routing information; and the transmission control protocol, or TCP, according to which messages are actually broken up into IP packets for transmission for subsequent collection and reassembly. TCP/IP connections are quite commonly employed to move data across telephone lines.

The Internet supports a large variety of information-transfer protocols. One of these, the World Wide Web (hereafter, simply, the “web”), has recently skyrocketed in importance and popularity; indeed, to many, the Internet is synonymous with the web. Web-accessible information is identified by a uniform resource locator or “URL,” which specifies the location of the file in terms of a specific computer and a location on that computer. Any Internet “node”—that is, a computer with an IP address (e.g., a server permanently and continuously connected to the Internet, or a client that has connected to a server and received a temporary IP address)—can access the file by invoking the proper communication protocol and specifying the URL. Typically, a URL has the format http://<host>/<path>, where “http” refers to the HyperText Transfer Protocol, “host” is the server's Internet identifier, and the “path” specifies the location of the file within the server. Each “web site” can make available one or more web “pages” or documents, which are formatted, tree-structured repositories of information, such as text, images, sounds and animations.

An important feature of the web is the ability to connect one file to many other files using “hypertext” links. A link appears unobtrusively as an underlined portion of text in a document; when the viewer of this document moves the cursor over the underlined text and clicks, the link-which is otherwise invisible to the user—is executed and the linked file retrieved. That file need not be located on the same server as the original file.

Hypertext and searching functionality on the web is typically implemented on the client machine, using a computer program called a “web browser.” With the client connected as an Internet node, the browser utilizes URLs—provided either by the user or a link—to locate, fetch and display the specified files. “Display” in this sense can range from simple pictorial and textual rendering to real-time playing of audio and/or video segments. The browser passes the URL to a protocol handler on the associated server, which then retrieves the information and sends it to the browser for display; the browser causes the information to be cached (usually on a hard disk) on the client machine and displayed. The web page itself contains information specifying the specific Internet transfer routine necessary for its retrieval. Thus, clients at various locations can view web pages by downloading replicas of the web pages, via browsers, from servers on which these web pages are stored. Browsers also allow users to download and store the displayed data locally on the client machine.

The number of servers accessible just on the web is enormous and constantly growing. Locating pages of interest is frequently a haphazard process, requiring the user to recall complex URL designations, to have previously “bookmarked” the site, or to find the site using a publicly accessible “search engine” such as ALTA VISTA, EXCITE or YAHOO. At the same time, the proliferation of potentially objecitonable content on the web has engendered efforts toward allowing parents and network administrators to restrict access to inappropriate sites.

### DESCRIPTION OF THE INVENTION

Brief Summary of the Invention

The present invention facilitates or limits interaction with a computer network based on a tangible token, such as a small card or disk, a small everyday article, a toy, or a product container. The token comprises a machine-readable indication, or “tag,” that identifies the token and which may be wirelessly read by a tag reader. The tag reader communicates the identifier to a computer connected to the network as a node. The computer, in response, implements a network-access criterion based on the token (or more specifically, the token's identifier). Generally, the computer maintains a database relating token identifiers to associated network-access criteria, and consults the database when presented with an identifier.

The access criterion directly affects interaction between the computer and the network, and can serve to initiate connections or restrict them. The access criterion can specify, for example, a particular node on the network or a file on that node (e.g., in an Internet context, by means of a URL). The computer may be programmed to respond to the access criterion by connecting to the specified node and, if a file is specified, to retrieve that file across the network. Again, in an Internet context, the specified node may be a web server and the file a web page stored on that server; in this case, the computer is equipped with suitable browser software to display the web page.

The access criterion can also impart information to the specified node following connection thereto. For example, in addition to specifying a file for retrieval, the access criterion can include an authentication code that is transmitted by the computer, and which confirms to the node authorization to retrieve the specified file. Alternatively, the access criterion can include information specific to the token itself, the computer communicating this information to the node as a means, for example, of identifying or categorizing the user.

The reader may be configured to automatically read tokens brought within its read range and to communicate identifiers to the computer upon their detection. The computer, for its part, may be configured for immediate response, looking up the access criterion and taking the action specified (or implied) therein. In this way, access to a specific, restricted file may be obtained merely by bringing the token into proximity to the reader. Desirably, the reader is implemented in a form that facilitates direct coupling to the computer without the need for separate, external packaging. In a preferred approach, the reader is integrated within a mouse pad that serves the ordinary function of such an accessory, but also communicates with tokens and with the computer. The reader may take different forms for implementations not involving stand-alone computers; for example, in the case of a television featuring web access, the reader may be incorporated into the television's remote control unit.

The access criterion can govern network interaction in a negative sense rather than an affirmative one. That is, the criterion can specify a “filter” or blocking program that automatically restricts the nodes to which the computer can connect or, more typically, the kinds of files it is permitted to download from the network. Internet filter programs are readily available and include, for example, SURFWATCH (marketed by Spyglass Inc.) and CYBER PATROL (sold by Microsystems Software). Such programs may include customizable restrictions that the access criterion can specify. For example, CYBER PATROL allows restrictions to be set up on the basis of site lists (e.g., node identifiers), word lists, categories of objectionable content, or type of site (e.g., the web generally, file transfer, newsgroups, IRC Chat, games). The access criterion may implement restrictions specific to the token by enabling network access but also causing the computer to launch a filter program, supplying to that program a specified set of restrictions governing its operation. Without the token, the user is precluded from accessing the network at all.

While the access criteria are typically specified by a single token, this need not be the case. The user may place a plurality of tokens within the range of the reader, the access criterion being determined by all the identifiers detected by the reader.

The invention is amenable to a wide variety of applications. Generally, the tokens in some way govern access to the computer network, and may contain some visual cue associating them with the access criterion. For example, the tokens may bear a pictorial rendering associated with particular web sites, allowing users to access the depicted web site merely by presenting the token to the reader. The tokens can also serve as identification, a useful application in a multi-user computing environment where no user is consistently assigned to a particular machine. For example, a classroom may have only a single computer; but by giving each student a unique token, network access can be personalized to each student. The degree of personalization is limited only by the amount of information stored in the computer's database. Thus, the database record for each identifier can include the student's name, his or her usage history, the last site visited, and instructions for causing the computer to take action different from the default model of web-site access. In this way, students can immediately resume previously interrupted sessions with the computer merely by presenting the token; the computer consults the database record and effectively re-establishes the student's previous network environment. By lodging relevant information in the computer's database, the tag is effectively able to orchestrate complex data-driven activities with minimal onboard storage.

The token may also be a product. For example, prescription drug containers can contain an embedded tag specifying not only the manufacturer's web site, but the particular web page having consumer information relevant to the drug, or even information personalized to the individual purchaser; in this way, the tag replaces the traditional paper “package insert” with online information containing the most up-to-date information. Two such containers placed in proximity to the reader can cause display of interaction information. For example, each container may specify the URL of the manufacturer's home page and also a data item identifying the particular drug; the computer connects to the web server and provides, over the network connection, both drug identifiers.

The information contents of the token are not limited to simple identifiers, however, and it is not necessary that the access criterion be lodged in the computer. The token can, for example, contain circuitry capable of storing network addresses themselves, as well as receiving and storing additional information. In an exemplary application, the token is embedded into the hub of an automobile key, and is configured to upload and store engine and mileage information from the automobile's internal computer through the metal key shank. The token also contains the URL of the manufacturer's home page. When the key is brought into proximity to the reader, the URL and the uploaded data are transferred to the computer, which accesses the designated site and communicates the data thereto. The server responds by providing the user with appropriate diagnostic information.

### BRIEF DESCRIPTION OF THE DRAWINGS

The foregoing discussion will be understood more readily from the following detailed description of the invention, when taken in conjunction with the accompanying drawings, in which:

FIG. 1 schematically illustrates the basic components of the present invention;

FIG. 2 schematically illustrates a computer configured for operation in accordance with the present invention; and

FIG. 3 schematically illustrates a preferred reader implementation.

### DETAILED DESCRIPTION OF THE PREFERRED EMBODIMENTS

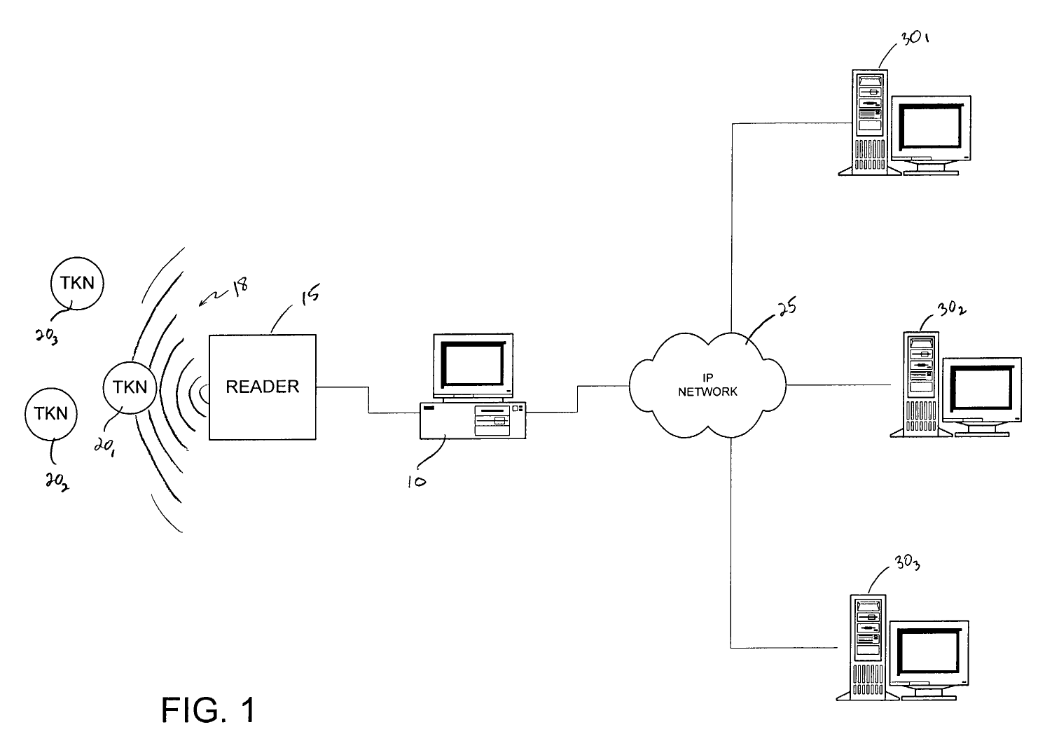

Refer first to FIG. 1, which illustrates, in block-diagram form, a representative system embodying the invention. A conventional computer 10 (usually a personal computer) is connected to and accepts incoming data from an RFID reader 15. Reader 15 emits a signal 18. If any of a series of tokens 20₁, 20₂, 20₃, each containing an embedded RFID tag (not shown) is within range of the signal 18, it will respond by providing its identifier to reader 15. Although the term “RFID” is an abbreviation of radio-frequency identification, it has attained a more generic connotation in the art. Accordingly, as used herein, the term “RFID” broadly connotes any system utilizing a wirelessly readable signature or code embedded into a minuscule package, typically a chip that can be incorporated within an article. The term “token” includes not only small items (such as easily carried cards or “poker chip” disks) intended solely as housings for the RFID tag, but also more commonplace articles—keychains, product containers, even household appliances-that incorporate the RFID tag.

The typical RFID tag is a small, low-power microchip combined with an antenna. Reader 15 transmits the excitation signal 18 that is received by the microchip (via the antenna), which uses the signal both as a source of power and as means of imparting information back to reader 15. For example, upon receiving power, the microchip may alter its input impedance in a temporal pattern specified by permanently stored instructions, the pattern conveying a unique digital code or identifier associated with the particular microchip. This pattern is registered by reader 15 as changes in reflected power, which are interpreted by reader 15 to reproduce the code and provide this to computer 10. Coupling between the microchips of tokens 20 and reader 15 may be magnetic (inductive coupling) or electric (capacitive coupling) in nature. In other embodiments, the RFID microchip can transmit a tiny voltage signal that is detected by the reader.

Computer 10 is also connected to a computer network 25; in the illustrated configuration, that network utilizes the Internet routing and transmission protocols (i.e., TCP/IP). By virtue of its connection to network 25, computer 10 is capable of establishing connections to and exchanging data with any other computer or “node” on network 25. Typically, IP network 25 is the Internet, but may instead be a smaller network (such as a corporate “intranet”) operating in accordance with the TCP/IP protocols. To establish a connection, a message and the address or name of the destination node is supplied to TCP/IP software running as an active process on computer 10. This software communicates the address to network 25, which routes the message appropriately. In a typical Internet interaction, computer 10 is a “client” and the contacted computer is a “server,” three of which are representatively (and alternatively) shown at 30₁, 30₂, 30₃.

In accordance with the invention, each token 20 may be associated with a different server 30; that is, token 20₁ may be intended to cause computer 10 to establish communication with server 30₁, while token 20₂ specifies server 30₂ and token 20₃ specifies server 30₃. Because only token 20₁ is within the range of signal 18, computer 10 establishes a connection to server 30₁. Tokens 20 may include no more than a preprogrammed RFID chip, or may have more elaborate circuitry enabling acquisition of data from sources to which it is coupled by contact or wirelessly.

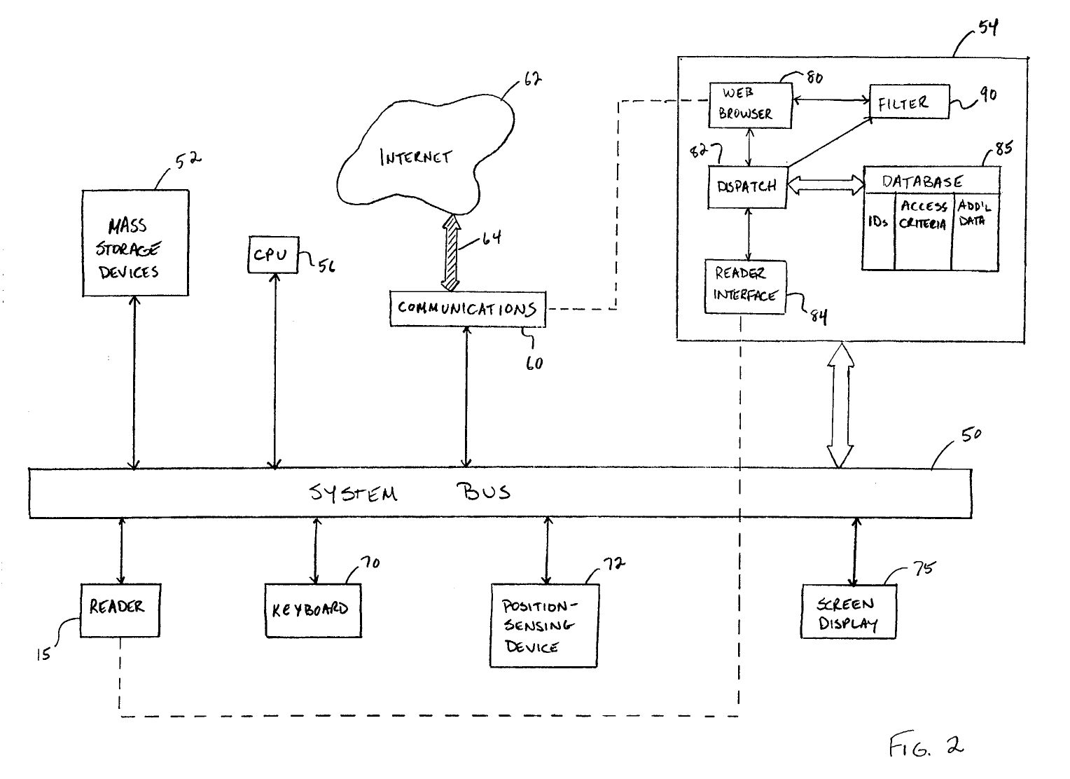

FIG. 2 depicts a representative implementation of a client computer 10 incorporating the invention. Once again, although the illustrated embodiment involves an Internet environment, it should be stressed that the invention is not limited to such an environment.

The illustrated system includes a bidirectional bus 50, over which all system components communicate, at least one mass storage device (such as a hard disk or optical storage unit) 52, and a main system memory 54. Operation of the system is directed by a central-processing unit (“CPU”) 56. A conventional communication platform 60, which includes suitable network interface capability and transmission hardware, facilitates connection to and data transfer through a computer network 62 (which may be, as illustrated, the Internet) over a telecommunication link 64. For example, computer 10 may be part of a LAN connected directly to the Internet, in which case platform 60 represents the network adapter; or may instead be connected via an Internet service provider, in which case platform 60 represents a modem and a TCP/IP stack.

The user interacts with the system using a keyboard 70 and a position-sensing device (e.g., a mouse) 72. The output of either device can be used to designate information or select particular areas of a screen display 75 to direct functions to be performed by the system.

The main memory 54 contains a group of modules that control the operation of CPU 56 and its interaction with the other hardware components. An operating system (not shown) such as WINDOWS directs the execution of low-level, basic system functions such as memory allocation, file management and operation of mass storage device 52, multitasking operations, input/output and basic graphics functions for output on screen display 75. The user's primary interactions with the network 62 occur over a web browser 80, which operates as a running process and contains functionality for establishing connections to other nodes on network 62, and for fetching therefrom web items (e.g., pages containing textual information) each identified by a URL. Web browser 80 temporarily stores these and causes their display on screen 75, also executing hyperlinks contained in web pages and selected by the user, and generally interpreting web-page information. Browser 80 may be any of the numerous available web browsers, e.g., NETSCAPE COMMUNICATOR (supplied by Netscape Communications Corp.), EXPLORER (provided by Microsoft Corp.) or MOSAIC (different versions of which are available free of charge at a variety of web sites).

The primary activities of the present invention are performed by a dispatch module 82, which receives reader signals from reader 15 (see FIG. 1) via a reader interface 84, which itself receives the reader's digital signals directly from bus 50. Dispatch module 82 and reader interface 84 are implemented as computer instructions executable by CPU 56, and run as active processes on computer 10. Generally, reader 15 automatically responds to tokens as they enter its read range by signaling computer 10. Reader interface 84 determines whether signals received from reader 15 in fact indicate the presence of a token, filtering noise and spurious signals in a conventional, known manner. Dispatch module 82 is preferably configured to respond immediately to the presence of signals received from reader interface 84. When dispatch module 82 receives an identifier from reader interface 84, it consults a database 85 to determine the action to be taken next.

Database 85 contains a series of access criteria, each of which is matched to an identifier or a group of identifiers (such that different combinations of tokens can uniquely specify particular actions). Database 85 can also contain additional information pertinent to particular identifiers, as described in greater detail below. Accordingly, upon receipt of an identifier, dispatch module 82 queries database 85 to locate the corresponding access criterion and any other stored information relating to the identifier, and takes appropriate action based thereon. If desired, the identifier can be based not only on the identity of the token, but on reader 15 as well. That is, reader 15 can identify itself when transmitting the RFID contents of a token, so that the action taken by dispatch module 82 depends on both the token and the reader; the same token, therefore, can produce different actions on different readers.

Most simply, with web browser 80 running as an active process, dispatch module 82 obtains from database 85 a URL associated with the received identifier, and causes web browser 80 to connect to the referenced server and download the specified web page. (Dispatch module 82 can also be configured to launch web browser 80 upon receipt of an identifier if the web browser is not currently active.) If the access criterion obtained from database 85 contains data (e.g., identification or authorization information), dispatch module 82 causes browser 80 to forward this to the accessed server. The user is then free to interact with the server over web browser 80, using keyboard 70 and/or mouse 72, in the normal fashion. Unless and until another token reaches the vicinity of reader 15, dispatch module 82 takes no further action.

The access criteria can also specify an Internet blocking filter 90, as well as restriction parameters that determine the scope of its operation. If filter 90 is not already running as an active process, dispatch module 82, in response to located access criteria specifying the filter 90, launches it with any specified restriction parameters. Filter 90 then operates in the normal fashion, governing access by web browser 80 to Internet files and sites.

The additional data linked to an identifier in database 85 is used to personalize the user's interaction with network 62, and typically includes historical information that permits the user to resume a previous session. For example, suppose that token 20 contains no more than an identifier. The access criteria corresponding to this identifier might include an authorization level, a filter program with attendant restrictions, and the URL of a preferred startup web page. The additional information associated with the identifier might include the token-holder's name, a set of “bookmarks” that specify URLs of the token-holder's frequently visited sites, and a list of the most recently visited sites. When the token-holder presents the token 20 to reader 15, computer 10 immediately learns the tokenholder's identity, and web browser 80 is effectively customized for this individual. Web browser 80 accesses the token-holder's specified startup web page, and allows him or her to operate the web browser to revert to previously visited or bookmarked sites as if continuing the previous session.

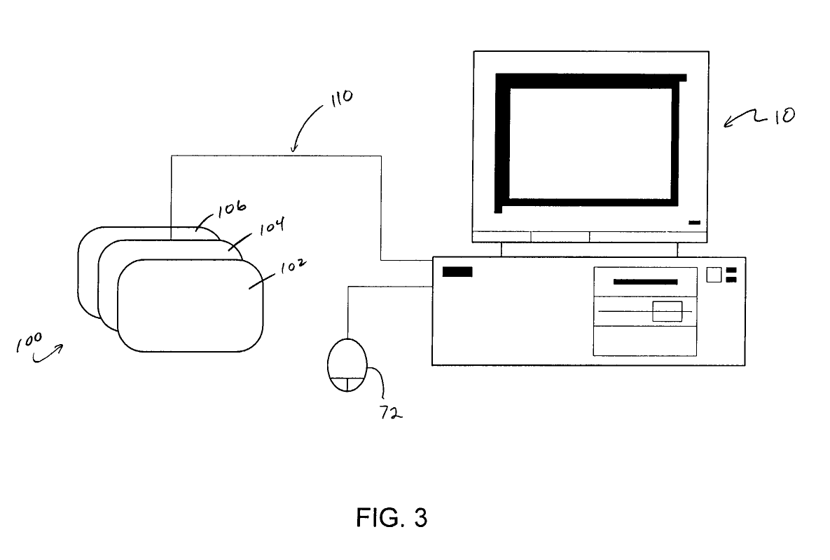

Refer now to FIG. 3, which illustrates a preferred form of reader, indicated generally at 100. The reader 100 is designed to operate as a mouse pad, thereby physically dissociating it from the computer 10 while not adding a separate, dedicated piece of equipment to the system. The illustrated reader 100 is a multilayer structure comprising a topmost mouse-pad layer 102, a circuitry layer 104, and a backing layer 106.

Layer 102 comprises a conventional mouse-pad surface designed to operatively receive a mouse such that the mouse rolls freely and reliably across the surface. Layer 102 may also have a PVC stiffener behind the surface material. Layer 104 is preferably a closed-cell foam pad that provides resilience and houses the reader circuitry. For example, layer 104 may have cutouts of appropriate shape to receive the circuitry, thereby forming a protective, insulating boundary around the electronic components. Generally, layer 104 will be about 0.5 inch thick. Backing layer 106 is preferably a rubberized, non-skid material. Layers 102, 104, 106 have similar planar dimensions and are adhesively joined to one another to form a single, substantially continuous structure that rests on a surface in a flat configuration. The overall dimensions of the structure 100 are similar to those of conventional mouse pads, with perhaps some difference in thickness.

Layer 104 also contains a port for receiving one or more cables 110 that carry power and data. For example, cable 110 may be configured to carry serial data between the reader 100 and computer 10, and power to operate the reader circuitry. In use, tokens are brought into proximity with reader 100, or merely placed on surface layer 102, thereby causing computer 10 to execute the operations discussed above.

Many other reader configurations are of course possible. Ideally, the reader is implemented in a contextually integrated fashion with respect to the network-access device in order to obviate the need for an additional piece of equipment. For example, in the context of a television configured for network access (e.g., so-called NetTV with access to the Internet), the reader can be implemented as part of the television's remote control unit. Presentation of a token to the remote control unit causes the unit to transmit a signal identifying the token the television, which contains the operative components (other than reader 15) shown in FIG. 2. The television, in response, accesses the computer or file specified by the token. In this context, the token can alternatively specify a television channel. As a result, the invention can be used to control the television both in the traditional sense and as a network-access device.

It will therefore be seen that we have invented a highly versatile and conveniently implemented approach to controlling access to computer networks. The terms and expressions employed herein are used as terms of description and not of limitation, and there is no intention, in the use of such terms and expressions, of excluding any equivalents of the features shown and described or portions thereof, but it is recognized that various modifications are possible within the scope of the invention claimed.

What is claimed is:

1. In a computer network comprising a plurality of linked nodes, a method of controlling access between a first node and other nodes on the network, the method comprising the steps of:
a. providing a tangible token comprising an identifier; and
b. wirelessly reading the identifier and, in response thereto, establishing an access criterion between the node and at least one other node on the network.

2. The method of claim 1 wherein the identifier is uniquely associated with a second node on the network, the access criterion including the address of the second node, the establishment step comprising identifying the second node, and further comprising the step of causing the first node to connect to the second node based on the access criterion.

3. The method of claim 2 wherein the access criterion further specifies a file on the second node, and further comprising the step of causing the first node to retrieve the file from the second node following connection thereto.

4. The method of claim 3 wherein the network is the Internet, the second node is a web server, and the file is a web page, the first node including a browser for displaying the web page.

5. The method of claim 1 wherein the token comprises an RFID chip containing the identifier, the reading step being performed by an RFID reader in wireless communication with the RFID chip and also coupled to the first node, the reader supplying power to the RFID chip and reading the identifier therefrom.

6. The method of claim 1 wherein the wireless reading step is performed by a reader having a read range, the reading step occurring upon entry of the token within the read range.

7. For use in conjunction with a system comprising a computer linked to a computer network comprising a plurality of nodes, and a reader for wirelessly acquiring data from a tangible token and communicating the data to the computer, a computer-readable medium encoded with executable instructions for causing the computer to establish an access criterion between the computer and a node on the network.

8. The medium of claim 7 further comprising instructions for causing the computer to (i) establish a database relating a plurality of token identifiers with access criteria associated therewith, and (ii) consult the database, in response to a token identifier communicated by the reader, to locate and implement the access criterion associated with the identifier.

9. The medium of claim 7 wherein at least some of the access criteria designate a node on the network, implementation of such access criteria causing the computer to establish a connection to the designated node.

10. The medium of claim 9 wherein at least some of the node-designating access criteria further designate a file on the node, implementation of such access criteria causing the computer to obtain the designated file.

11. An information reader for interfacing with a computer, the reader comprising:
a. a pad for resting on a surface in a flat configuration and having a pad surface for operatively receiving a rolling position-sensing device;
b. circuitry, physically associated with the pad but not interfering with its interaction with the position-sensing device, for wirelessly reading an RFID identifier; and
c. means for communicating with the computer.

12. The reader of claim 11 wherein the circuitry electrically couples to the RFID identifier.

13. The reader of claim 11 wherein the circuitry magnetically couples to the RFID identifier.

14. The reader of claim 11 wherein the reader is a layered structure comprising a pad layer having a set of planar dimensions and an operative layer disposed beneath the pad layer, the operative layer containing the circuitry and having planar dimensions conforming to those of the pad layer.
